(19) United States
(12) Patent Application Publication
(10) Pub. No.: US 2017/0000108 A1
(43) Pub. Date: Jan. 5, 2017

(54) Game Calling Device Having Adjustable Sound and Method for Using

(71) Applicant: Hunters Specialties, Inc., Cedar Rapids, IA (US)

(72) Inventors: Ron Bean, Cedar Rapids, IA (US); Scott Thomas, Marion, IA (US)

(73) Assignee: Hunters Specialties, Inc., Cedar Rapids, IA (US)

(21) Appl. No.: 15/196,174

(22) Filed: Jun. 29, 2016

Related U.S. Application Data
(60) Provisional application No. 62/186,901, filed on Jun. 30, 2015.

(51) Int. Cl. A01M 31/00

(52) U.S. Cl. CPC A01M 31/004

(57) ABSTRACT

An animal call commonly referred to as a grunt tube. The animal call generally includes an elongated housing, a reed, an expandable member, and an adjustment member. The housing includes a mouthpiece end that allows air to enter the tubular member, an outlet end that emits sounds, and an opening in a wall of the tubular member between the mouthpiece end and the outlet end. The reed vibrates in response to passing air and is disposed within the housing near the mouthpiece end and the opening. An adjustment member has an adjustment arm which contacts the reed. A user can modify the sounds emanating from the outlet end by changing the position of the adjustment arm along the length of the reed to change the vibrational characteristics of the reed. The expandable member is made from a flexible and elastic material thereby allowing it to have a first position wherein it is retracted and a second position where it is extended.

### CROSS-REFERENCE TO RELATED APPLICATION

The present invention claims priority to Provisional Patent Application Ser. No. 62/186,901, filed Jun. 30, 2015, the disclosure of which is hereby expressly incorporated by reference.

### BACKGROUND

The present invention relates to game calling devices, and in particular, to an adjustable grunt tube that can produce sounds having varied pitch, intensity, tone and inflection.

Game calling devices for large mammals and predators are known. In particular, devices known as “grunt tubes” are used to simulate the grunts, snorts, bleats and other sounds produced by white-tailed deer. Hunters and wildlife enthusiasts use grunt tubes to attract deer and other animals.

Grunt tubes generally include a tubular member through which air passes and a reed supported within the tubular member. The passing air excites the reed causing it to vibrate and produce sounds. Some grunt tubes allow the user to vary the sounds produced by the calling device. In one existing device the sound is varied by adjusting the position of an o-ring along the length of the reed. One problem with this device is that the o-ring can be difficult for the user to access since the reed/o-ring assembly is positioned inside the central housing of the device. Another problem with this device is that it can be difficult for the o-ring to make contact all the way around the circumference of the reed which can hinder the reed's vibration and distort the sound. Yet another problem with this device is that the o-ring requires periodic lubrication to prevent it from drying out.

There is therefore a need for an improved grunt tube which overcomes these and other disadvantages in the prior art.

### SUMMARY

One aspect of the invention relates to an animal call device commonly referred to as a grunt tube. The animal call generally includes an elongated housing, a reed, an expandable member, and an adjustment member. The housing includes a mouthpiece end that allows air to enter the tubular member, an outlet end that emits sounds, and an opening in a wall of the tubular member between the mouthpiece end and the outlet end. The reed vibrates in response to passing air and is disposed within the housing near the mouthpiece end and the opening. An adjustment member has an adjustment arm which contacts to the reed. A user can modify the sounds emanating from the outlet end by changing the position of the adjustment arm along the length of the reed to change the vibrational characteristics of the reed. The expandable member is made from a flexible and elastic material thereby allowing it to have a first position wherein it is nested inside the housing and a second position wherein a portion extends outside of the housing. In one embodiment the expandable member is biased in its first position so that it retracts inside the housing when the user no longer exerts a pulling force on the outlet end.

Another aspect of the invention relates to a method of using an animal call. The animal call generally includes an elongated housing having a mouthpiece end and an outlet end, a reed, an expandable member, and an adjustment member having an adjustment arm in frictional engagement with the reed. The method includes passing air into the mouthpiece end of the housing as is known in the art. The reed vibrates in response to the passing air to create an audible sound which is emitted from the outlet end of the device. The sound emanating from the outlet end is modified by changing the position of the adjustment arm along the length of the reed to change the vibrational characteristics of the reed. The expandable member has a first position wherein it is nested inside the housing and a second position wherein a portion extends outside of the housing. The expandable member is biased in its first position so that it retracts inside the housing when the user no longer exerts a pulling force on the outlet end. The expandable member may be moved to its extended position to increase the distance between the mouthpiece end and the outlet end which modifies the sound emitted. In its extended position the expandable member may be bent or flexed to modify the direction of sound emitted from the outlet end.

### BRIEF DESCRIPTION OF THE DRAWINGS

FIG. 1 is a side section view of an embodiment of the grunt tube showing the adjustment member in a first position along the length of the reed.

FIG. 2 is a side section view of an embodiment of the grunt tube showing the adjustment member in a second position along the length of the reed.

FIG. 3 is a perspective view of the adjustment member.

FIG. 4 is a side section view of an embodiment of the grunt tube showing the expandable member in its extended position.

FIG. 5 is a side view of the adjustment member with the arm in a compressed position.

FIG. 6 is a side view of the adjustment member with the arm in the relaxed position.

FIG. 7 is a top view of the reed on the sound board with the stop members along the edges of the sound board.

FIG. 8 is a side section view of an embodiment of the grunt tube showing the adjustment member sliding along the inside surface of the housing.

### DETAILED DESCRIPTION

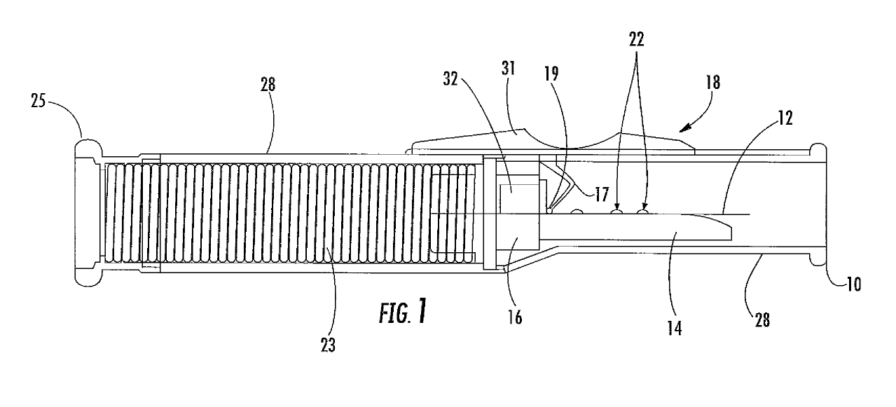

As shown in FIG. 1, one embodiment of the grunt tube generally includes a housing 28, a reed 12, an expandable member 23, and an adjustment member 18. The housing 28 includes a mouthpiece 10 at one end which allows air to enter the housing 28 and an outlet end 25 at the other end which emits sounds. As used herein, “upstream” is toward the mouthpiece 10 and “downstream” is toward the outlet 25. An opening in a wall of the housing 28 extends between the mouthpiece 10 and the outlet 25 to allow air to pass through the length of the housing 28. The housing 28 has an inner surface and an outer surface and may be made of any suitable material. In one embodiment the housing 28 is made from a solid material such as hard plastic polymer. The housing 28 can be any suitable shape, including tubular and rectangular prism.

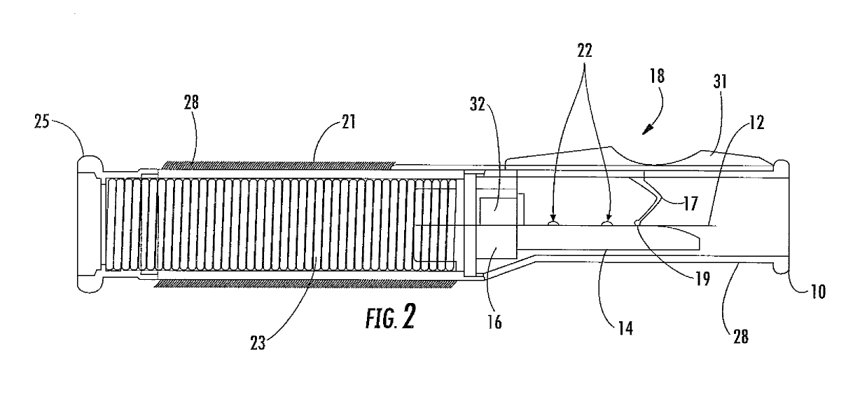

The reed 12 is disposed within the housing 28 in alignment with the mouthpiece 10 opening. The reed 12 is a thin strip of a flexible material, such as, e.g., plastic or MYLAR. As known in the art, the dimensions of the reed 12 and the material of which it is made are determined according to the sound characteristics that the user desires to produce with the grunt call. The reed 12 is supported by a sound board 14 (FIGS. 1-2) and a reed support member 16. In some embodiments the sound board 14 and support member 16 are molded together as one piece. A removable wedge 32 is used to secure the reed 12 to the sound board 14. After the reed 12 is positioned adjacent to the sound board 14, the wedge 32 is placed on top of the downstream portion of the reed 12 and forced into an opening having a size and shape approximately the same as the wedge 32. The wedge 32 is frictionally secured in the opening to hold the reed 12 against the sound board 14. In some embodiments the opening or wedge 32 may be tapered so the friction between the wedge 32 and the walls of the opening increases as the wedge 32 is pushed farther into the opening.

In some embodiments, the length of the sound board 14 is shorter than the length of the reed 12 to help slow down the reed's 12 vibrations. In other embodiments the reed 12 is longer than the sound board 14. Depending upon the desired sound characteristics, however, different sound board 14 configurations can be used. The sound board 14 preferably includes an upstream end disposed adjacent the mouthpiece 10 which is tapered to be thinner than the downstream end thereby allowing the upstream portion of the reed 12 to be suspended away from the sound board 14. The reed 12 preferably includes an upstream end that is also disposed adjacent the mouthpiece 10 and a downstream end. The downstream end of the reed 12 is connected to the downstream end of the sound board 14 as described above. The upstream end of the reed 12 is free to vibrate away from the sound board 14, subject to the position of the adjustment member 18 as described below.

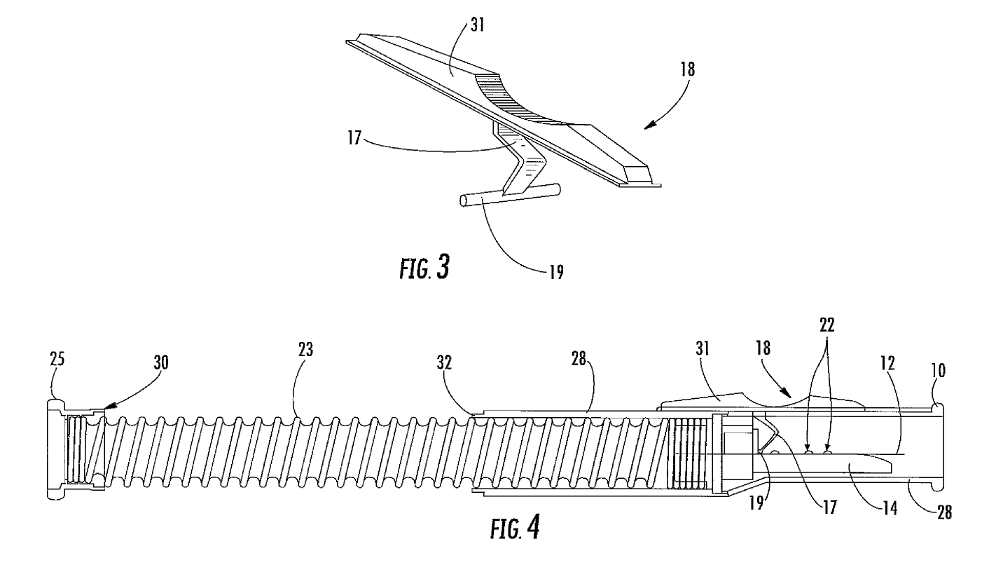

In some embodiments an expandable member 23 is combined with the housing 28 so that air passing through the opening in the wall of the housing 28 passes through an opening in the wall of the expandable member 23. The expandable member 23 is made from a flexible and elastic material such as rubber. The expandable member 23 has a first position wherein it is refracted and a second position wherein it is extended. In some embodiments the expandable member 23 has an outer surface with a diameter smaller than the outer diameter of the housing 28 thereby allowing the expandable member 23 to be nested inside the housing 28 in its first position as shown in FIGS. 1 and 2. In its second position at least a portion of the expandable member 23 is pulled outside of the housing 28 as shown in FIG. 4 such that the outer surface of the expandable member 23 is not within the housing 28. In some embodiments the expandable member 23 is biased in its first position so that it retracts inside the housing 28 when the user no longer exerts a pulling force on the outlet end 25.

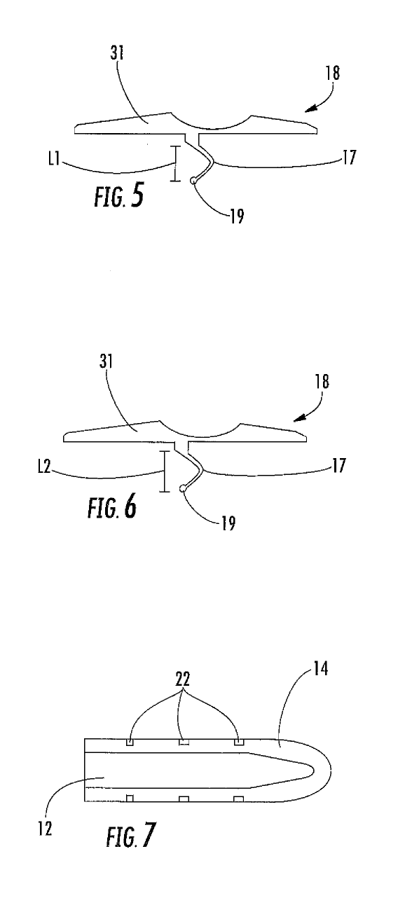

A first end of the expandable member 23 is combined with any upstream portion of the animal call, preferably at a point immediately downstream from the reed 12. The second end of the expandable member 23 is combined with the outlet end 25 of the housing 28. The outlet end 25 is separable from the main housing member (the portion of the housing 28 between the outlet end 25 and the mouthpiece 10 is referred to herein as the main housing member). The upstream end of the outlet end 25 mates with the downstream end of the main housing member when the expandable member 23 is in its first position. As shown in FIG. 4, in some embodiments the upstream portion of the expandable member 23 is combined with the housing 28 near the reed support member 16 and the downstream portion of the expandable member 23 is combined with the outlet end 25. In these embodiments the outlet end 25 is made from a hard material which may be the same material as the housing 28. The outlet end 25 has a lip or seat 30 which has a diameter larger than the diameter of the downstream end of the housing 28 so it is adapted to receive the rim 32 of the downstream end of the housing 28. When combined, the seat 30 and rim 32 form an airtight seal between the two components so they effectively function as one solid body. In another embodiment the upstream end of the outlet end 25 and the downstream end of the housing 28 are machine tapered to be self holding. In one embodiment the machine taper is a Morse taper. The biasing force of the expandable member 23 pulling the outlet end 25 toward the housing 28 causes the separate components 25, 28 to create a seal (FIGS. 1 and 2) such that the entirety of the housing 28 and outlet end 25 function as a solid body grunt tube unless the user applies force to pull the outlet end 25 away from the main housing member as shown in FIGS. 4 and 5.

FIG. 8 shows an alternate embodiment having an expandable member 23 capable of moving between a first and second position as described above. In this alternate embodiment at least a portion of the expandable member 23 is outside of the housing 28 even when the expandable member 23 is in its first (retracted) position. In this alternate embodiment the grunt call is not completely enclosed by a solid body housing when the expandable member 23 is in its first position.

The sounds produced by the grunt call can be varied in several ways. First, the user can partially or completely cover the outlet end 25 to change the pitch. Second, the length of the device may be varied by extending or retracting the expandable member 23 to change the length of the internal opening to change the pitch. The flexibility of the expandable member 23 also allows the direction of the sound to be varied by flexing or bending the expandable member 23 when it is in its extended position so the outlet end 25 directs sound in a direction other than along the longitudinal axis of the animal call. Third, the user can invert the grunt call and produce different sounds by inhaling through the outlet end 25 of the call instead of exhaling through the mouthpiece 10.

Another way to vary the sound of the call is to change the effective length of the reed 12 using the finger-actuated adjustment member 18. The adjustment member 18 has an engaging portion 31 adapted to slide along the outer surface of the housing 28 as shown in FIGS. 1 and 2. The adjustment member 18 may be mounted to a dovetail groove or slot in the housing 28 so that the engaging portion 31 remains outside the housing 28 and an adjustment arm 17 extends through the groove or slot. The adjustment arm 17 extends from the engaging portion 31 into the internal opening toward the reed 12. The adjustment arm 17 has a contact end 19 which frictionally engages the reed 12 and presses the reed 12 against the sound board 14. Moving the engaging portion 31 of the adjustment member 18 along the length of the housing 18 effectively provides infinite adjustment along the length of the reed 12. In one embodiment the adjustment arm 17 is a curved rigid resilient member having a first position wherein the arm 17 is lax (FIG. 6) and a second position wherein the arm 17 is compressed (FIG. 5). The positions of the arm 17 are shown in FIGS. 5 and 6 wherein the length L1 between the engaging portion 31 and the contact end 19 is shorter in the compressed position (FIG. 5) than the corresponding length L2 in the lax position (FIG. 6). The arm 17 is biased in its first position. The adjustment member 18 is combined with the housing 28 such that the arm 17 is compressed to its second position. The resiliency of the arm 17 trying to return to its first position exerts force against the reed 12 to change the effective length of the reed 12 (the vibrating portion of the reed 12 upstream from the arm 17).

The user can adjust the effective length of the reed 12 by moving the adjustment member 18 along the housing 28 which changes the point at which the contact end 19 engages the reed 12. In FIG. 1 the adjustment member 18 is shown in a first position contacting a first point on the reed 12 wherein the entire length of the reed 12 is allowed to vibrate. In FIG. 2 the adjustment member 18 is shown in a second position wherein the adjustment arm 17 contacts a second point on the reed 12 thereby preventing much of the reed 12 from vibrating. This in turn changes the point at which the reed 12 engages the sound board 14 which shortens the effective length of the reed 12 thereby changing its sound as it vibrates.

FIG. 8 shows an alternate embodiment of the grunt tube having an adjustment member 18 capable of engaging and sliding along the length of the reed 12 to change the effective length of the reed 12 as described above. The adjustment member 18 in this alternate embodiment is similar to the ones described above because a portion of it is accessible by the user from outside the housing 28; however, the adjustment member 18 shown in this embodiment has an engaging portion 31 which slides along an inside surface of the housing 28 instead of along the outside surface of the housing 28.

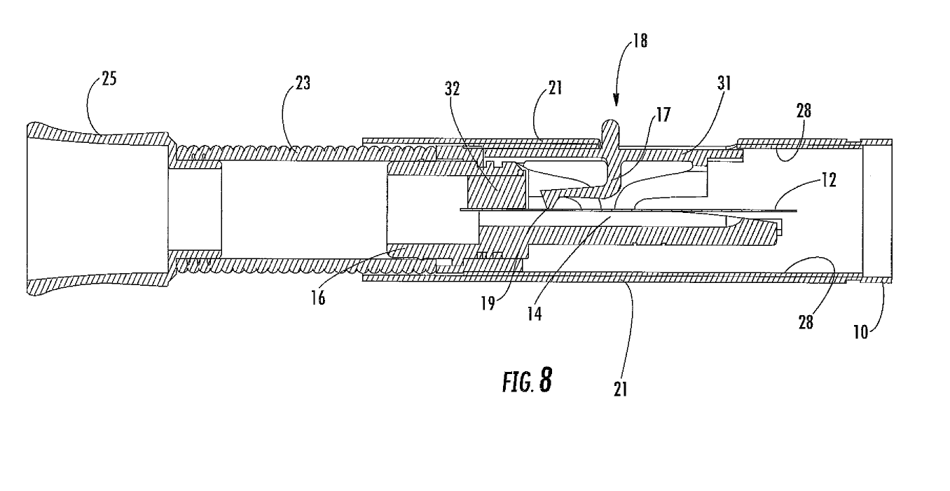

In some embodiments the sound board 14 includes one or more stop points 22 which may be ridges elevated above the surface of the sound board 14 or grooves indented below the surface of the sound board 14. The stop points 22 are located at predetermined positions along the length of the sound board 14. These predetermined positions create a known pitch or sound which may be useful for the user. The stop points 22 create an increased amount of friction between the arm 17 and the stop point 22 which can be felt by the user as the adjustment member 18 is moved along the length of the housing 28 to signal the position of the stop points 22. In the embodiment shown in FIG. 7, the stop points 22 do not extend across the entire width of the top surface of the sound board 14. Instead, the sound board 14 is wider than the reed 12 and the stop points 22 are located along the outer edges of the top surface of the sound board 14 on one or both sides of the reed 12. In these embodiments the arm 17 approximates the width of the sound board 14 so that it contacts the stop points 22 to create an increased amount of friction but the reed 12 does not make contact with the stop points 22. In addition, the outside of the housing 28 may include a visual marking to denote predetermined positions of the adjustment member 18. The visual markings may align with the position of the stop points 22 or they may be independent from the position of the stop points 22.

In some embodiments at least a portion of the housing 28 is covered by a soft skin 21 such as an elastic or synthetic or natural rubber as shown in FIGS. 2 and 8. The skin 21 material has a non-reflective matte black finish. In addition to reducing reflections, the rubber material also minimizes any sounds produced by incidental contact between the grunt call and other objects, such as, e.g., a hunter's weapon.

To use the device a user passes air into the mouthpiece 10 end of the housing 28 as is known in the art. The reed 12 vibrates in response to the passing air to create an audible sound which is emitted from the outlet 25 end of the device. The reed 12 is secured to a sound board 14 by placing the reed 12 on the sound board 14 then placing a wedge 32 on top of the reed 12 and into an opening where the wedge 32 is frictionally secured by the walls of the opening. The reed 12 is sandwiched between the wedge 32 and the support member 16 and/or sound board 14. The sound emanating from the outlet 25 end is modified by changing the position of the adjustment member 18 along the length of the reed 12 to change the vibrational characteristics of the reed 12. The user may move the adjustment member 18 to certain predetermined stop points 22 along the length of the sound board 14. An expandable member 23 is combined with the housing so that air passing through the housing 28 is directed through the expandable member 23. The expandable member 23 has a first position wherein it is nested inside the housing 28 and a second position wherein a portion extends outside of the housing 28. The expandable member 23 is biased in its first position so that it retracts inside the housing 28 when the user no longer exerts a pulling force on the outlet 25 end. The expandable member 23 may be moved to its extended position to increase the distance between the mouthpiece 10 end and the outlet 25 end which modifies the sound emitted. In its extended position the user may bend or flex the expandable member 23 to modify the direction of sound emitted from the outlet 25 end.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. An animal call comprising:
an elongated housing having an outer surface, a mouthpiece, an outlet end, and an opening in a wall of the housing between the mouthpiece and the outlet end;
a reed that vibrates in response to passing air, said reed being disposed within said opening;
an adjustment member having an adjustment arm in frictional engagement with the reed and adapted to slide along the length of the reed to change the effective length of the reed.

2. The animal call of claim 1 wherein the adjust member further comprises an engaging portion and a contact end, said engaging portion and contact end connected by the adjustment arm.

3. The animal call of claim 2 wherein the elongated housing has a slot adapted to receive the adjustment arm allowing the engaging portion of the adjustment member to slide along the outer surface of the elongated housing and the contact end of the adjustment member to engage the reed.

4. The animal call of claim 1 wherein the adjustment member includes an engaging portion slidable along an inner surface of the elongated housing.

5. The animal call of claim 1 wherein at least a portion of the reed is supported by a sound board, the sound board having a width larger than a width of the reed.

6. The animal call of claim 5 wherein the sound board includes one or more stop points.

7. The animal call of claim 6 wherein the sound board has an outer edge extending beyond the width of the reed and the stop points are on the outer edge.

8. The animal call of claim 6 wherein the stop points are elevated above a surface of the sound board.

9. The animal call of claim 5 wherein the adjustment member exerts a biasing force to press the reed against the sound board.

10. An animal call comprising:
an elongated housing having an outer surface, an inner surface, a mouthpiece, an outlet end, and an opening in a wall of the housing between the mouthpiece and the outlet end;
a reed that vibrates in response to passing air, said reed being disposed within the opening of the elongated housing;
an adjustment member having an engaging portion slidable along the elongated housing between a first position and a second position and an adjustment arm in frictional engagement with the reed and adapted to slide along the length of the reed to change the effective length of the reed.

11. The animal call of claim 10 wherein the elongated housing has a slot adapted to receive the adjustment arm allowing the engaging portion of the adjustment member to slide along the outer surface of the elongated housing and the adjustment arm to engage the reed.

12. The animal call of claim 10 wherein the engaging portion of the adjustment member is slidable along the inside surface of the elongated housing.

13. The animal call of claim 10 wherein at least a portion of the reed is supported by a sound board, the sound board having a width larger than a width of the reed.

14. The animal call of claim 12 wherein the sound board includes one or more stop points.

15. An animal call comprising:
an elongated housing having a mouthpiece, a main housing member, an outlet end, and an opening in a wall of the elongated housing between the mouthpiece and the outlet end;
a reed that vibrates in response to passing air, said reed being disposed within said opening;
an expandable member having a first position and a second position, in the first position the expandable member is nested inside the elongated housing and in the second position at least a portion of the expandable member extends outside of the elongated housing.

16. The animal call of claim 15 wherein the expandable member is biased in the first position.

17. The animal call of claim 15 wherein the expandable member has a first end combined with an upstream portion of the animal call and a second end combined with the outlet end, wherein the outlet end is separated from the main housing member when the expandable member is in the second position.

18. The animal call of claim 17 wherein the outlet end has a seat adapted to receive a rim portion of the main housing member to create a seal when the expandable member is in the first position.

19. The animal call of claim 15 wherein the expandable member is bendable.

20. The animal call of claim 15 wherein the elongated housing is made from a solid material such as hard plastic polymer.

21. The animal call of claim 15 wherein there is a first distance between the mouthpiece and the outlet end when the expandable member is in the first position and a second distance between the mouthpiece and the outlet end when the expandable member is in the second position, and wherein the second distance is longer than the first distance.

22. A method of using an animal call to produce a sound, said method comprising:
taking an animal call having a reed with a first contact point and a second contact point, said reed disposed within an elongated housing having an outside surface, a main housing member, a mouthpiece end, an outlet end, and an adjustment member having a reed engagement arm in frictional engagement with the reed at the first contact point;
conveying air through said mouthpiece end and past said reed, thereby causing said reed to vibrate and to produce sounds that emanate from said outlet end; and
sliding the adjustment member along the housing to cause the reed engagement arm to move from the first contact point against the reed to the second contact point against the reed to modify the sound.

23. The method of claim 22 wherein the animal call further comprises an expandable member having a first end combined with an upstream portion of the animal call and a second end combined with the outlet end and the method further comprises moving the expandable member from a first position where it is nested inside the elongated housing to a second position where at least a portion of the expandable member extends outside of the elongated housing.

24. The method of claim 23 wherein the animal call has a longitudinal axis and the method further comprises bending the expandable member to project the sound in a direction other than along the longitudinal axis.
